(19) United States
(12) Patent Application Publication
(10) Pub. No.: US 2012/0189999 A1
(43) Pub. Date: Jul. 26, 2012

(54) SYSTEM AND METHOD FOR USING OPTICAL CHARACTER RECOGNITION TO EVALUATE STUDENT WORKSHEETS

(75) Inventors: Todd Maurice Uthman, Rochester, NY (US); Frank Porter, Penfield, NY (US); Adam D. Ledgerwood, Geneva, NY (US)

(73) Assignee: Xerox Corporation, Norwalk, CT (US)

(21) Appl. No.: 13/012,359

(22) Filed: Jan. 24, 2011

(51) Int. Cl. G09B 7/00

(52) U.S. Cl. 434/335

(57) ABSTRACT

A system and method for evaluating worksheets are provided. The method includes accessing by a processor a digitally stored image of a worksheet that was administered to a student, wherein the worksheet includes the presentation of at least one problem for the student to respond to and each problem presentation includes an answer region that the student manually, mechanically, or electronically marked with an answer to the problem using a variety of alphanumeric characters. The method further includes generating expected answer data that provides an expected answer for each answer region; locating each answer region in the image; extracting from each located answer region the student's marks; processing the student's marks extracted from each answer region with character recognition processing; and storing the processed marks as student answer data. The student answer data is evaluated by comparing the student answer data with the expected answer data and generating corresponding evaluation data.

### CROSS-REFERENCE TO RELATED APPLICATIONS

The present application is related to U.S. application Ser. Nos. 12/339,979, 12/340,054, 12/340,116, all filed on Dec. 19, 2008, U.S. application Ser. No. 12/054,824, filed Mar. 25, 2008, U.S. application Ser. No. 11/749,192, filed May 16, 2007, U.S. application Ser. No. 12/771,534, filed Apr. 30, 2010, U.S. application Ser. No. 12/840,584, filed Jul. 21, 2010, and U.S. application Ser. No. 12/958,768, filed Dec. 2, 2010.

### TECHNICAL FIELD

The present disclosure relates generally to a system and method for using intelligent character recognition (ICR) to evaluate student worksheets. In particular, the present disclosure relates to detecting and extracting student entered answers and comparing to an answer guide.

### BACKGROUND

Students are frequently administered worksheets, such as homework, quizzes and tests to practice material that they have been taught and to be evaluated in their mastery of the material. These worksheets are typically paper documents that the student marks up by handwriting answers on the paper document. There are educational and logistical advantages to having a student hand-write their answers directly onto the worksheet that is administered to them. Many of these advantages are lost when the student must use a standardized answer sheet or use a computer to complete their work. However, teachers may spend large amounts of time evaluating and/or grading students' handwritten worksheets.

### SUMMARY

The present disclosure is directed to a worksheet evaluator system for evaluating worksheets administered to at least one student. The system includes at least one tangible processor and a memory with instructions to be executed by the at least one tangible processor for accessing by a processor a digitally stored image of a worksheet that was administered to a student. Each worksheet includes the presentation of at least one problem for the student to respond to and each problem presentation includes an answer region that the student manually, mechanically, or electronically marked with an answer to the problem using a variety of alphanumeric characters.

The executable instructions are further executed for generating expected answer data that provides an expected answer for each answer region, locating each answer region in the image of the administered worksheet, and extracting the student's marks from each located answer region. The executable instructions are further executed for processing the student's marks extracted from each answer region with character recognition processing (CRP) and storing the processed marks that corresponds to each answer region as student answer data. The executable instructions are further executed for evaluating the student answer data by comparing the student data with the expected answer data and generating corresponding evaluation data.

The present disclosure is also directed to a method for evaluating worksheets administered to at least one student. The method includes accessing by a tangible processor a digitally stored image of an answer sheet that is a copy of a worksheet. The worksheet includes the presentation of at least one problem for a student of the at least one student to respond to and each problem presentation includes an answer region for the student to manually, mechanically, or electronically mark an answer to the problem in the answer region using a variety of alphanumeric characters. The answer sheet includes recognizable optical markings associated with each answer region.

The processor locates each answer region by locating the optical markings associated with each answer region in the image of the answer sheet, and stores by the processer location data that includes a location that corresponds to each located optical marking associated with each answer region. The processor generates expected answer data that provides an expected answer for each answer region. The processor accesses a digitally stored image of a worksheet that was administered to a student of the at least one student, wherein the student manually, mechanically, or electronically marked the answer region associated with each problem with an answer to the problem in the answer region using a variety of alphanumeric characters. The processer locates each answer region in the image of the administered worksheet using the location data and extracts the student's marks from each answer region located in the image of the administered worksheet.

The processor processes the extracted student's marks with character recognition processing (CRP) and stores the processed marks that correspond to each answer region as student answer data. The processor evaluates the student answer data by comparing the student data with the expected answer data and generates corresponding evaluation data.

The present disclosure is also directed to another embodiment of a method for evaluating worksheets administered to at least one student. The method includes accessing by a tangible processor a digitally stored image of an answer sheet that is a copy of a worksheet. The worksheet includes the presentation of at least one problem for a student of the at least one student to respond to. Each problem presentation includes an answer region for the student to mark with an answer to the problem manually, mechanically, or electronically using a variety of alphanumeric characters.

The answer sheet includes recognizable optical markings associated with each answer region and teacher entered marks associated with each answer region. The processor locates each answer region by locating the optical markings associated with each answer region in the image of the answer sheet. The processor stores location data that includes a location that corresponds to each located optical marking associated with each answer region. The processor extracts from each answer region located in the image of the answer sheet the teacher's marks that are marked in the answer region and processes the extracted teacher marks with CRP and generates expected answer data including an expected answer that corresponds to each answer region.

The processor accesses a digitally stored image of a worksheet that was administered to a student of the at least one student, wherein the student manually, mechanically, or electronically marked the answer region associated with each problem with an answer to the problem in the answer region using a variety of alphanumeric characters. The processor locates each answer region in the image of the administered worksheet using the location data and extracts from each answer region located in the image of the administered worksheet the student's marks. The processor processes the extracted student's marks with CRP and stores the processed marks that correspond to each answer region as student answer data. The processor then evaluates the student answer data by comparing the student data with the expected answer data and generating corresponding evaluation data.

Other features of the presently disclosed recommender system will become apparent from the following detailed description, taken in conjunction with the accompanying drawings, which illustrate, by way of example, the presently disclosed recommender system.

### BRIEF DESCRIPTION OF THE DRAWINGS

Various embodiments of the present disclosure will be described below with reference to the figures, wherein:

FIG. 1 is a schematic diagram of an exemplary academic worksheet generator system in accordance with the present disclosure;

FIG. 2 shows a detailed block diagram of the components of the worksheet generator system shown in FIG. 1 in accordance with the present disclosure;

FIG. 3 shows an exemplary worksheet in accordance with the present disclosure;

FIG. 4 shows a flowchart of a first embodiment of a method for evaluating worksheets in accordance with the present disclosure;

FIG. 5 shows a flowchart of a second embodiment of a method for evaluating worksheets in accordance with the present disclosure; and

FIG. 6 shows a flowchart of a third embodiment of a flowchart of a method for evaluating worksheets in accordance with the present disclosure.

### DETAILED DESCRIPTION

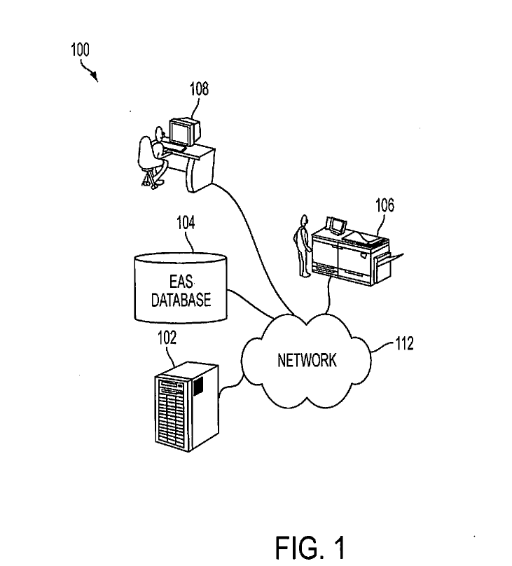

Referring now to the drawing figures, in which like references numerals identify identical or corresponding elements, the educational recommender system and method in accordance with the present disclosure will now be described in detail. With initial reference to FIG. 1, an exemplary worksheet evaluator system in accordance with the present disclosure is illustrated and is designated generally as worksheet evaluator system 100.

Worksheet system evaluator 100 includes a server 102, data storage facility 104, at least one multifunction device (MFD) 106 and workstation 108. Each of the components of worksheet evaluator system 100 is in data communication with at least one of the other components via network 112.

The server 102 receives an evaluation request from a teacher to evaluate one or more student worksheets. The request includes a template and at least one digital worksheet file generated by scanning in worksheets that were administered to one or more students during which the students marked their answers on their respective worksheets. The server 102 uses the template and/or recognizable optical markings on the worksheets, such as highlighting or graphical delimiters, to extract the students' answer marks from the digital worksheet file. The server 102 processes the extracted marks using character recognition processing (CRP), which may include Optical character recognition (OCR) and/or intelligent character recognition (ICR) and generates corresponding response data for each problem. The server 102 uses the template to evaluate the response data and grade the worksheets. The server 102 stores for each student the corresponding response data and the results of the evaluation and grading. The ICR may be improved by providing training data to the server 102 for each student.

The template may be generated by the teacher via workstation 108 or may by created by server 102 by processing a digital answer sheet generated by scanning in an answer sheet. The answer sheet is a copy of the worksheet which the teacher marked with the expected or correct answers. The server 102 uses recognizable optical markings on the answer sheet, such as highlighting or graphical delimiters, to extract the teacher's answer marks from the digital answer sheet. The server 102 processes the extracted marks using CRP and generates corresponding answer data for each problem. The CRP may be improved by providing training data to the server 102 for each teacher.

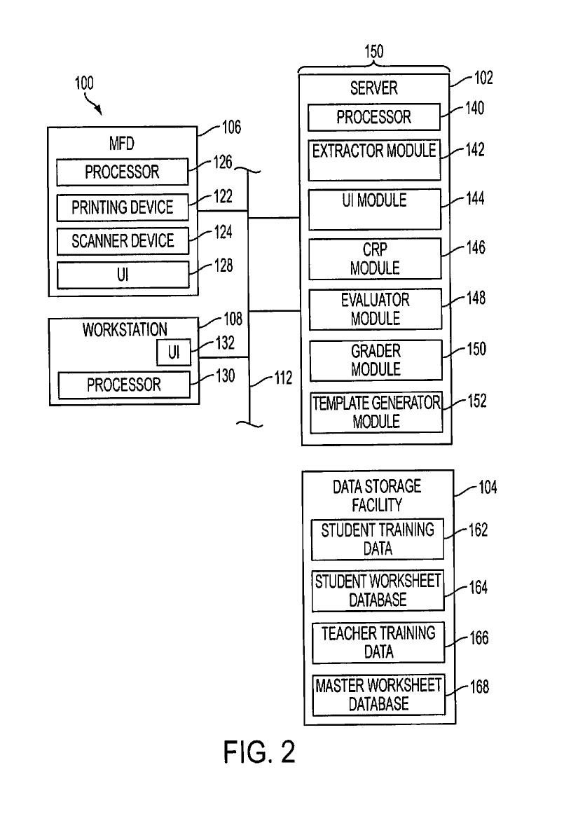

Referring to FIG. 2, the server 102 is a computing device having a hardware processor 140 (e.g., a microprocessor or CPU); at least one storage device (e.g., RAM, ROM, flash memory, removable memory, etc.), and all necessary communication devices for communicating with the data storage facility 104, MFD 106, and/or workstation 108, either directly or via the network 112. The server 102 may include a web server, a server, a minicomputer, a mainframe computer, a personal computer, a mobile computing device, etc.

The processor 140 executes an extractor software module 142, a user interface software module 144, a CRP software module 146, an answer evaluator software module 148, a grader software module 150, and template generator module 152, each of which is described further below. The extractor software module 142, user interface software module 144, CRP software module 146, answer evaluator software module 148, grader software module 150, and template generator module 152 each include a series of programmable instructions capable of being executed by the processor 140. The series of programmable instructions can be stored on a computer-readable medium accessible by the processor 140, such as RAM, a hard drive, CD, smart card, 3.5″ diskette, etc., for performing the functions disclosed herein and to achieve a technical effect in accordance with the disclosure. The functions of the extractor software module 142, user interface software module 144, CRP software module 146, answer evaluator software module 148, grader software module 150, and template generator module 152 may be combined into one module or distributed among a different combination of modules and/or among different servers.

The data storage facility 104 includes at least one nonvolatile storage device for storing information that the server 102 needs to access when evaluating a student worksheet. Software necessary for accessing data in the data storage facility 104, including retrieving data, manipulating data and storing data, may be included with the server 102 and/or the data storage facility 104. The server 102 and the data storage facility 104 may be configured as one component or may be configured as separate components which are in data communication.

The data storage facility 104 may be a central database, a distributed database, or may include local storage associated with one or more of the components (e.g., server 102, MFD 106, workstation 108) of the worksheet evaluator system 100. The components may share information (such as worksheets and answer sheets, student and teacher training data, templates, scanned worksheets and answer sheets, answer data, validated answer data, evaluation data, validated evaluation data, worksheet grades, and reports related to evaluations of worksheet) by storing information in and retrieving information from data storage facility 104. The method of sharing information may be done in a number of ways, such as a first component notifying a second component when a particular file is available for the second component to retrieve or process, the first component sending the file to the second component, or the second component checking the data storage facility 104 at regular intervals for files that it needs to retrieve for processing.

The data storage facility 104 includes student training data 162, student worksheet database 164, teacher training data 166 and master worksheet database 168. The student training data 162 includes digital images of handwriting samples for each of the students that were or will be administered worksheets. For example, the handwriting samples may be a sample of each character or symbol that the student may use when marking a worksheet with a response. The handwriting samples may further include a sample of the student's signature.

The student worksheet database 164 stores a plurality of worksheet images each corresponding to a paper worksheet copy that was administered to a student and scanned, e.g., with each worksheet image stored in a digital folder, file, record, or field. Related student worksheet (SW) data is associated with each worksheet image and included in the worksheet database 162. The related SW data may be associated with the worksheet image and stored in a variety of ways, such as stored in an associated folder, file, record, or field or provided as associated metadata. The related SW data includes, for example, an ID code identifying the worksheet image; an ID code identifying the student that the worksheet was administered to; an ID code identifying the template used for evaluating the worksheet image; header information and student answers extracted from the administered worksheet image; associated evaluation results; associated grade results; and an associated report.

The teacher training data 166 includes digital images of handwriting samples for the teachers that generate answer sheets. For example, the handwriting samples may be a sample of each character or symbol that the teacher may use when marking an answer sheet with an expected answer. The handwriting samples may further include a sample of the teacher's signature.

The master worksheet database 168 stores a plurality of master worksheet (MW) data sets. Each MW data set may be stored in a digital folder, file, record, or field. The MW data set includes a print-ready worksheet suitable for printing and administering to one or more students in order for the students to mark responses to problems presented on the worksheet in designated answer regions 304. The MW data set may also include an answer sheet image corresponding to a paper copy of the printer-ready worksheet for administering to a teacher for the teacher to mark with expected answers, and then scanned. The printer-ready worksheet and the answer sheet image may be stored, for example, in a digital folder, file, record, or field.

Related master worksheet (MW) data is associated with each MW data set and included in the MW database 168. The related MW data may be associated with the printer-ready worksheet or answer sheet image and stored in a variety of ways, such as stored in an associated folder, file, record, or field or provided as associated metadata. The related MW data includes, for example, one or more ID codes identifying the MW data set and its components, an ID code identifying the teacher that created the MW data set, extracted expected answer data (pre-CRP), extracted header information (pre-CRP), header information (post-CRP), and a template.

The template includes data that is used for evaluating student answers on a worksheet. The template includes, for example, identification (ID) code identifying the template, the teacher (i.e., author) of the template, a timestamp indicating the date and/or time that the template was generated, answer location data, expected answer data (post-CRP), evaluation rules, and grading rules.

The answer location data describes the location of a header region and each answer region. The expected answer data indicates the expected answer that corresponds to each answer location. The expected answer data or header information may further provide rules for evaluating each student answer, such as by indicating when: more than one answer is required for correctly answering a problem; when alternative answers are acceptable for correctly answering a problem; when the analysis of an answer should be sensitive to selected criteria, such as spelling, capitalization, punctuation, grammar, selected mathematical notations, etc.

The evaluation rules may be entered by the teacher via workstation 108, such as by using a GUI provided by the workstation 108. Alternatively, the evaluation rules may be handwritten or otherwise entered by the teacher on the answer sheet with the expected answers using symbols that indicate to the evaluator module 148 that a rule is stated, wherein the evaluator module 148 is configured to recognize and apply the stated rule. As another alternative, the evaluation rules may be printed on the worksheet. For example, the symbol “˜” may indicate a logical “OR,” signifying alternative expected answers, and the symbol “+” may indicate a logical “AND,” signifying multiple required expected answers. Other rules may be delimited by a symbol or symbol combination, such as “//,” wherein any characters bounded by the delimiting symbols are processed as rules. For example, “//sp//” may specify a rule that the comparison between the student answer and the expected answer is spelling sensitive. The evaluation rules may be designated as applying to one or more problems. For example, if the rule was included with an expected answer it may apply to the associated problem. If the rule was included with the header information, it may apply to all of the problems or a specified group of problems.

The grading rules are rules for assigning a grade to a student's worksheet based on the evaluation result for each of the problems. For example, the grading rules may indicate grading criteria, including a weight associated with each problem for assigning an overall grade for the worksheet; the format in which a grade is expressed (e.g., a percentage value, with 100% indicating that all problems were answered correctly, a letter grade (e.g., A+. A, A− . . . F), a descriptive grade (e.g., excellent, very good, good, fair, poor); and/or whether or not to curve a worksheet for a selected group of students (e.g., a grade, a class, a school district) and the method to use for curving the grades.

The grading rules may be entered by the teacher via workstation 108, such as by using a GUI provided by the workstation 108. Alternatively, the grading rules may be handwritten or otherwise entered by the teacher on the answer sheet with the expected answers or the header information using symbols that indicate to the grader module 150 that a grading rule is stated, wherein the grader module 150 is configured to recognize and apply the stated rule. As another alternative, the grading rules may be printed on the worksheet. For example, the symbol “%” may indicate that a weight for grading the problem associated with the expected answer is indicated by a number that follows the “%” symbol.

The MFD 106 includes a printing device 122, a scanner device 124, a processor 126, a user interface (UI) 128, and all necessary communication devices for communicating with the data storage facility 104, server 102, and/or client computing device 108, either directly or via the network 112. The printing device 122, scanner device 124, and processor 126 may be integrated and housed in a single housing or may be separate components which are interfaced to one another. The printing device 122 includes any apparatus or system, such as a digital copier, xerographic printing system, ink jet printing system, reprographic printing system, bookmaking machine, facsimile machine, etc., which performs a marking output function for any purpose. The modality for marking may include, for example, applying toner, ink, dye, etc., to a substrate. The substrate may be a material such as paper, cardboard, a transparency, a paper derivative, etc.

The scanner device 124 of the MFD 106 includes hardware and software for imaging a document and generating corresponding imaging data. A scanner device 124 may be provided in each classroom of a school building so that the teacher can submit worksheets to the scanner without leaving the classroom. The scanner devices 124 may be stand-alone devices or may be in communication with network 112 and/or one or more of the devices that are in communication with network 112. Each scanner device responds to a request to scan a document by imaging the document and generating a corresponding digital file of image data. The image data may be stored locally or in a central location, e.g., in data storage facility 140, that is accessible to processor 140 of server 102.

The workstation 108 is a computing device, such as personal computer or a mobile computing device, having a hardware processor 130 (e.g., a microprocessor or CPU); a UI 132; at least one storage device (e.g., RAM, ROM, flash memory removable memory, etc.), and all necessary communication devices for communicating with the data storage facility 104, MFD 106, and/or server 102, either directly or via the network 112. The UI 132 includes a user input device, such as a keyboard, keypad, touchpad, mouse, touch screen or the equivalent, and a display device, such as indicator lights, a display screen, etc. The UI 132 may provide a GUI via which the user may enter and receive information. The processor 130 may communicate with the server 102, data storage facility 104, and/or MFD 106, for receiving input from and generating output to a user via the UI 132, and to process data for generating worksheets 300.

The teacher may use the workstation 108 to generate a printer-ready worksheet, prepare expected answer data, prepare location data, prepare a template, validate student answer data, validate header information extracted from a worksheet or answer sheet image and processed with CRP, validate expected answers extracted from an answer sheet and processed with CRP, generate rules for evaluating or grading, request that a processing task be performed to a worksheet or answer sheet image, request that evaluation of a worksheet image be performed, validate the evaluation, view the evaluation, request a report, validate a report, view a report, etc.

The network 112 may be the Internet, an intranet, an Ethernet, a LAN, a WAN, or other means for providing data communication between a plurality of digital devices. It is also envisioned that the data communication between any of the components of the recommender system 100 may be via a direct connection which may be wired or wireless. In the present example, the network 112 is the Internet.

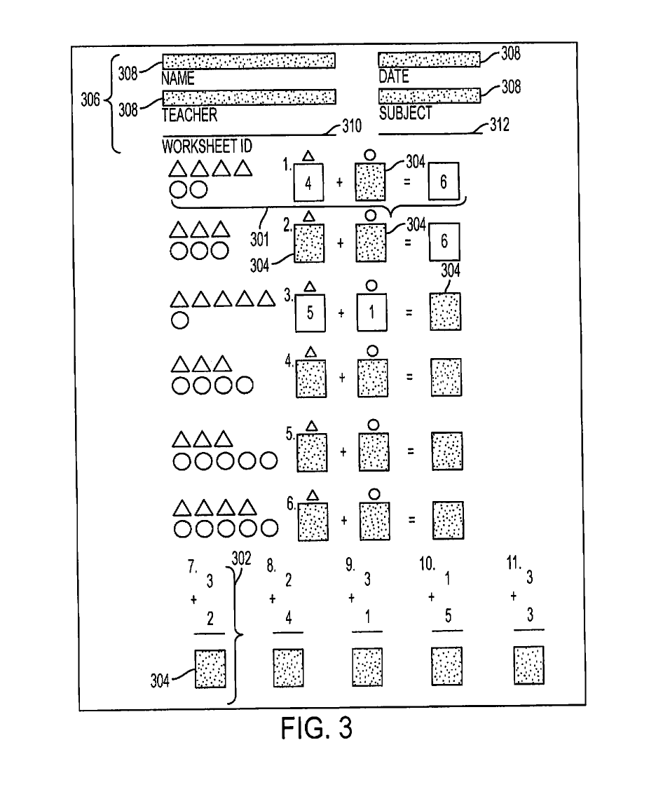

An exemplary copy of worksheet 300 is shown in FIG. 3. The worksheet 300 is a document, such as a homework sheet, practice worksheet for classroom use, quiz, or test (also referred to as an assessment) that may include one or more pages, which is provided on a substrate, e.g., paper, and which may be printed or handwritten. The worksheet may also be a form that is used for non-academic use, such as a form used by an administrative agency. Each worksheet 300 includes a presentation of at least one problem 302. Each problem 302 has an associated answer region 304. When the worksheet 300 is administered to a student, the student is expected to respond to each problem 302 with a written answer, e.g., a handwritten answer, in the corresponding answer region 304. The student may enter the answer manually (e.g., by handwriting), mechanically (e.g., by a using a manual or electronic printing device (a printer, a typewriter, a stamp), or electronically (e.g., by using a printer and/or a computing device), wherein the entered student answers includes a variety of alphanumeric characters.

The answer regions 304 may be defined by the template using location data that describes the location of the answer regions 304 or it may be defined by machine recognizable optical markings on the worksheet 300, such as highlighting or graphical delimiters. The highlighting or graphical delimiters may graphically show the boundaries of an answer region 304, or they provide enough information for the processor 140 to determine the boundaries, In the present example, the answer regions 304 are highlighted, which is shown as shaded. When the extraction module 142 processes the worksheet image, it may use the highlighting or other optical markings to locate the answer regions 304 in order to extract a student's answer marks from the answer regions 304 and perform CRP (e.g., OCR and/or ICR) on them. An example of the detection of highlighted regions for performing CRP on that region is described in U.S. Pat. Nos. 5,272,764 and 5,619,592, which are herein incorporated by reference.

The worksheet 300 also includes header region 306 which is designated with optical markings, such as highlighting or graphical delimiters. The highlighting or graphical delimiters may graphically show the boundaries of regions within answer region 304 in which identifying information is intended to be provided, or they provide enough information for the processor 140 to determine the boundaries, The header region may include information regions 308 for the student to write identifying information that identifies the student and the worksheet 300. This may include a name region, date region, teacher region, and subject region for the student to enter information, such as the student's name, the date, the name of the student's teacher, and the academic subject (e.g., math, social studies, spelling), respectively. The student may enter information into the header region 306 manually, mechanically, or electronically, wherein the entered information includes a variety of alphanumeric characters. Some of the information may be pre-printed using alphanumeric characters or optical codes. Worksheet ID region 310 is provided for entry of an identification (ID) code that identifies the worksheet 300. Some or all of the identifying information, including the worksheet ID, may be pre-printed on the worksheet 300 in the appropriate region using alphanumeric characters or an optical code.

Rule region 312 may be provided in which evaluation rules and/or grading rules may be pre-printed or handwritten by the teacher. When an evaluation rule appears in the header region 306, the rule applies to all of the problems, unless specified otherwise. Additional header regions 306 may be provided (not shown) as sub-headers that apply to a group of problems. The group of problems that the rule applies to may be designated optically, such as with an optically recognizable signal, such as a highlighted special symbol. When the extraction module 142 processes the worksheet image for extracting data, it may use the highlighting or other optical markings to locate the student input regions 308, worksheet ID region 310, and rule region 312 in order to extract the student's name, date, teacher's name, academic subject, worksheet ID, evaluating rules, and grading rules in order for the CRP module 146 to perform CRP on them. The rules may alternatively be entered by the teacher from the workstation 108, such as via a GUI, and stored with the template.

The answer sheet is a copy of the worksheet 300 in which the expected answers have been marked in the corresponding answer regions 304. The teacher may enter expected answers into the answer regions 304 manually, mechanically, or electronically, wherein the entered expected answers include a variety of alphanumeric characters. The answer regions 304 of the answer sheet are designated via optical markings, such as highlighting or graphical delimiters. The highlighting or graphical delimiters may graphically show the boundaries of an answer region 304, or they provide enough information for the processor 140 to determine the boundaries, The server 102 may learn the locations of the answer regions 304 and learn the boundaries by locating the optical markings that correspond to each answer region 304 in an image of the answer sheet generated by scanning the answer sheet with the scanner device 124. The location and boundaries that correspond to each answer region 304 are stored in the template as location data. Alternatively, the location data may be user selected and entered via workstation 108 when the user creates the template.

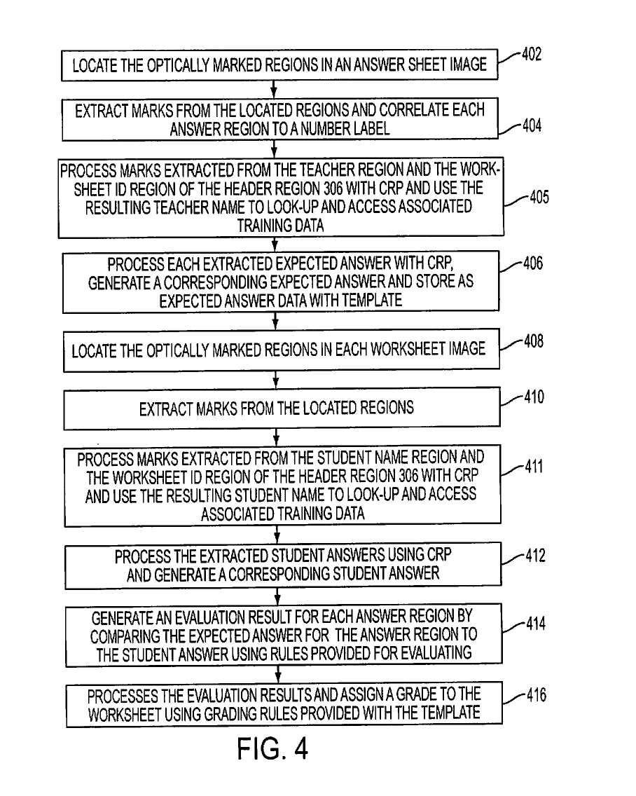

With reference to FIGS. 4-6, variations of a method for evaluating a student's worksheet are described. In the methods described, CRP is used to recognize responses that were handwritten by the student on the worksheet and may also be used to recognize expected answers that were handwritten by the teacher on the answer sheet. The results of the CRP may be improved by providing a handwriting sample for each student or teacher whose handwriting is analyzed by the CRP module 146.

The handwriting sample may include a sample of each character that the individual may use when marking a worksheet or answer sheet in the individual's own handwriting. The set of characters included in the handwriting sample, also referred to as a training character set, may include, for example, all of the alphanumeric characters and symbols that may be used in the future on worksheets or answer sheets, including capital and lower case samples, and including block and script samples. The handwriting sample is extracted by the extractor module 142 and processed by the CRP module 146 by using ICR. The CRP module 146 generates training data that includes a correlation of each character in the training character set to a selected character. The training data may be verified and corrected as necessary. Once training data is generated, the CRP module 146 used it for future ICR processing to improve accuracy.

With reference to FIG. 4, a first embodiment of a method for evaluating a worksheet 300 administered to a student is now described. The teacher generates an answer sheet by marking a copy of the worksheet 300 with expected answers in an answer region 304 that corresponds to each problem on the worksheet 300. The answer regions 304, identification regions 308, worksheet ID region 310, and rule region 312 are marked with recognizable optical markings, such as highlighting that indicate to the teacher where to place the expected answers when marking the answer sheet and further indicate to the extractor module 142 the location from which to extract the marked expected answers. The answer sheet is submitted to the scanning device 124 which generates a corresponding image file.

At step 402, the extractor module 142 processes the image file, including locating the optically marked regions by recognizing the optical markings and learning the regions' boundaries. A number label is assigned to each recognized answer region 304, e.g., by incrementing the number label by “1” each time an answer region 304 is located. At step 404, the extractor module 142 extracts marks entered in the located regions, e.g., answer regions 304 and the header region 306, and correlates the extracted expected answer with the answer region's number label.

At step 405, the CRP module 146 processes marks extracted from the header area 306. After the marks extracted from the teacher region 308 and the worksheet ID region 310 of header region 306 are processed using CRP, the resulting name formed by the characters is the teacher name and worksheet ID, respectively. The teacher name is used to look-up and access training data stored for the teacher who generated the answer sheet. The marks extracted from the date and subject regions 308, and the rules region 312 are processed using CRP and the resulting characters are stored and associated with the teacher and/or worksheet ID.

At step 406, the CRP module 146 processes each extracted expected answer with CRP, generating a corresponding expected answer. The expected answers are stored as expected answer data with the template, with each expected answer correlated to a numbered answer region 304. The teacher may view, correct, and verify the expected answer data from workstation 108, e.g., via a graphical user interface (GUI) provided with the workstation 108. The evaluator module 148 may check the expected answer to see if any evaluation rules or grading rules are included and store them accordingly.

The worksheet 300 is then administered to one or more students, e.g., a class of students. A worksheet 300 is administered to each student by providing the student with a paper copy of the worksheet 300 in which each answer region 304 is designated with a recognizable optical marking. The student marks the designated answer regions 304 of the worksheet 300, e.g., with a handwritten student answer using the training character set.

The marked worksheets are scanned by a scanning device 124, e.g., a scanning device 124 located in the classroom. The scanning device 124 generates an image for each scanned worksheet. At step 408, the extractor module 142 locates the optically marked regions in each image. At step 410, the extractor module 142 extracts the marks from each located region. The marks extracted from the answer regions 304 are the associated student answers.

At step 411, the CRP module 146 processes marks extracted from the header area 306. The characters forming the student name, date, teacher, subject, rules (if present), and worksheet ID are determined. The student name is used to look-up and access training data stored for the student who marked the worksheet 300. The date, teacher, subject, and rules are stored and associated with the student and/or worksheet ID.

At step 412, the CRP module 146 processes the extracted student answers using CRP, generating a corresponding student answer. The student answers are stored as student answer data, with each student answer correlated to a numbered answer region 304. The teacher may view, correct, and verify the student answer data from workstation 108, e.g., via a GUI provided with the workstation 108. Intelligent processing may be used by the CRP module 146 for processing the student answer. The intelligent processing may include, for example, spell-check and/or grammar-check processing that recognizes and compensates for spelling and/or grammar errors. An alert may be provided to the teacher each time that a correction is made.

At step 414, the evaluator module 148 accesses the student answer data and the expected data it compares the expected answer for each answer region 304 to the student answer, applying any evaluating rules for evaluating that may have been provided with the expected answer data or entered by the teacher. The student answer data may also be checked by the evaluator module 148 to see if it includes any evaluation rules to be applied. The evaluator module 148 may use intelligent processing when comparing the student answer and the expected answer. The intelligent processing may include, for example, determining an equivalent for the student answer (or the alternatively the expected answer) that can be used in substitute of the student answer (or alternatively expected answer), or ignoring spelling and/or grammar differences. The evaluator module 148 generates an evaluation result for each answer region 304.

Examples of applying rules are as follows. An exemplary question may ask “What are the colors of the U.S. flag?”, and may provide three reply regions 304 for the answer. The rule to be applied, which may be included in section 312 or with the expected answer, specifies that the student answer should include one each of “red,” “white,” and “blue,” in any order. Another exemplary question may ask “How many sides are on an octagon?” The rule to be applied, which also may be included in section 312 or with the expected answer, specifies that the either of the student answers “8” or “eight” are acceptable. The rule may be stated as “8 \\OR\\ eight,” where the symbol “\\” functions as a delimiter that bounds the logical “OR” operator.

At step 416, the grader module 150 processes the evaluation results and assigns a grade to the worksheet using the grading rules provided with the template. The teacher may view, correct, and verify the evaluation results and grade from workstation 108, e.g., via a GUI provided with the workstation 108. The evaluation results and/or grade for each student may be stored and associated with the student or the student's class and may further be available as input to another document or software module, such as to a spreadsheet or other report generating program.

The evaluation results may be analyzed, such as for comparing the student answer associated with an answer region 304 with the expected answer for an answer region 304 that precedes or follows it and detecting a student logistical error, such as accidentally skipping an answer region 304 by leaving it blank and placing the student answers in the wrong answer regions 304. Answer regions 304 associated with a detected logistical error may be highlighted. A teacher alert may be generated to notify the teacher of the detected possible logistical error.

In one embodiment, the header region 306 of the worksheet 300 or answer sheet may include pre-printed information. When the teacher generates worksheets for a class of students, a worksheet may be printed for each student with the student's name printed on it. The name, date, teacher, subject, worksheet ID, and/or rules may be pre-printed in alphanumeric characters and may further be encoded and printed in a machine readable optical code, such as a barcode. Once the barcode is extracted, such as at steps 404 or 410, an optical code decoder (not shown) may decode the encoded optical code and the decoded information is stored appropriately.

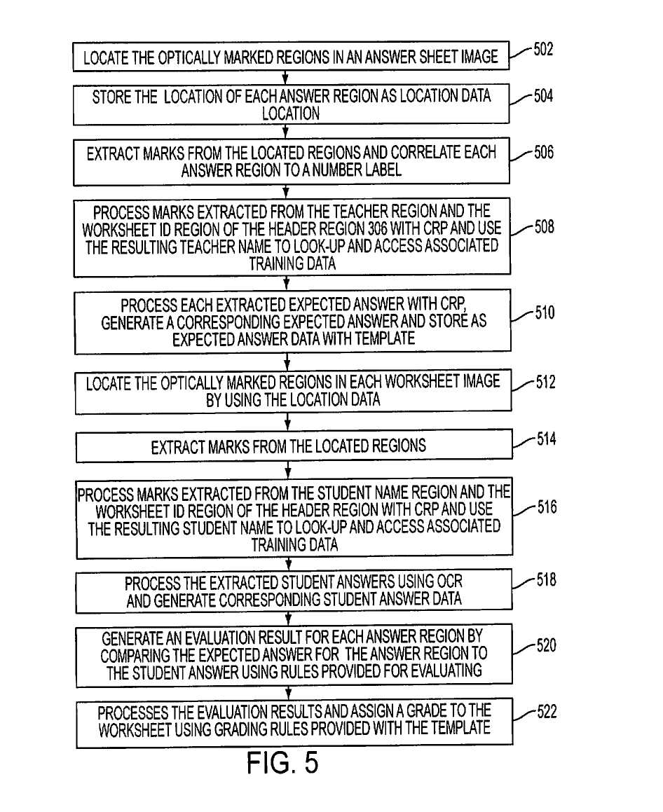

With reference to FIG. 5, a second embodiment of the method of evaluating a worksheet 300 administered to a student is now described in which location data is determined and generated based on the locations of the answer regions 304 in the image of the answer sheet. The answer sheet is generated, prepared, marked, and imaged as described with respect to FIG. 4. At step 502, the extractor module 142 processes the image file, and locates the optically marked answer regions 304 and their boundaries by recognizing the optical markings. A number label is assigned to each answer region 304. At step 504, the extractor module 142 stores the location of each answer region 304 as location data. The location data is stored with the template with the location of each answer region 304 correlated to a numbered answer region 304.

At step 506, the extractor module 142 extracts marks entered in the located regions, e.g., answer regions 304 and the header region 306, and correlates the extracted expected answer with the answer region's number label. At step 507, the CRP module 146 processes marks extracted from the header area 306. The characters forming the teacher name, date, subject, rules, and worksheet ID are determined. The teacher name is used to look-up and access training data stored for the teacher who created the answer sheet. The date, subject, and rules are stored and associated with the teacher and/or worksheet ID.

At step 508, the CRP module 146 processes each extracted expected answer with CRP, generating a corresponding expected answer. The expected answers are stored as expected answer data with the template, with each expected answer correlated to a numbered answer region 304. The evaluator module 148 may check the expected answer to see if any evaluation rules or grading rules are included and store them accordingly. The teacher may view, correct, and verify the expected answer data from workstation 108, e.g., via a graphical user interface (GUI) provided with the workstation 108.

As in the method described with respect to FIG. 4, the worksheet 300 is then administered to one or more students and the administered worksheets 300 are imaged. At step 510, the extractor module 142 locates the answer regions 304 in each image by using the location data. In accordance with this method it is not required that the answer regions 304 be marked with optical markings. At step 512, the extractor module 142 extracts the student answer from each answer region 304.

At step 513, the CRP module 146 processes marks extracted from the header area 306. The characters forming the student name, date, teacher, subject, rules (if present), and worksheet ID are determined. The student name is used to look-up and access training data stored for the student who marked the worksheet 300. The date, teacher, subject, and rules are stored and associated with the student and/or worksheet ID.

At step 514, the CRP module 146 processes the extracted student answers using CRP, generating a corresponding student answer. The student answers are stored as student answer data, with each student answer correlated to a numbered answer region 304. The teacher may view, correct, and verify the student answer data from workstation 108, e.g., via a GUI provided with the workstation 108.

At step 516, the evaluator module 148 accesses the student answer data and the expected data it compares the expected answer for each answer region 304 to the student answer using the rules for evaluating that may be provided with the expected answer data. The evaluator module 148 generates corresponding evaluation data including an evaluation result for each answer region 304 that indicates if the associated problem was answered incorrectly or correctly.

At step 518, the grader module 150 processes the evaluation results and assigns a grade to the worksheet using the grading rules provided with the template. The teacher may view, correct, and verify the evaluation results and grade from workstation 108, e.g., via a GUI provided with the workstation 108.

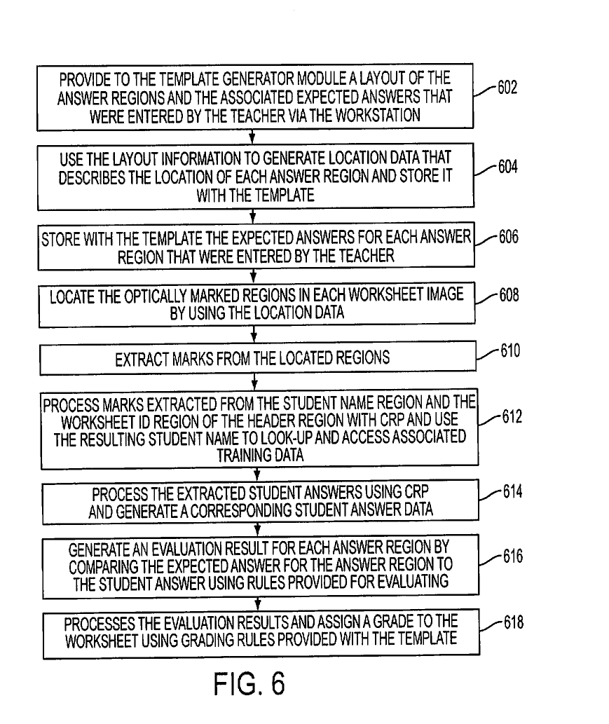

With reference to FIG. 6, a third embodiment of the method of evaluating a worksheet 300 administered to a student is now described. In this embodiment it is not necessary for the teacher to mark an answer sheet. Instead, the teacher provides the location data and expected answer data by entering the information via the workstation 108. The workstation 108 may provide a GUI in order that entry of the location data is intuitive and uncomplicated. For example, the workstation 108 may provide a graphical image of the worksheet 300 or alternative form via which the teacher enters the expected answers in provided answer regions 304. At step 602, the workstation 108 provides the layout of the answer regions 304 and the associated expected answers that were entered by the teacher to the template generator module 152. At step 604, the template generator module 152 uses the layout information to generate location data that describes the location of each answer region 304 and stores it with the template. At step 606, the template generator further stores with the template the expected answers for each answer region 304 that were entered by the teacher.

As in the method described with respect to FIG. 4, the worksheet 300 is then administered to one or more students and the administered worksheets are imaged. At step 608, the extractor module 142 locates the answer regions 304 in each image by using the location data provided with the template. At step 610, the extractor module 142 extracts the student answer from each answer region 304.

At step 611, the CRP module 146 processes marks extracted from the header area 306. The characters forming the student name, date, teacher, subject, rules (if present), and worksheet ID are determined. The student name is used to look-up and access training data stored for the student who marked the worksheet 300. The date, teacher, subject, and rules are stored and associated with the student and/or worksheet ID. At step 612, the CRP module 146 processes the answers using CRP, generating a corresponding student answer. The student answers are stored as student answer data, with each student answer correlated to a numbered answer region 304. The teacher may view, correct, and verify the student answer data from workstation 108, e.g., via a GUI provided with the workstation 108.

At step 614, the evaluator module 148 accesses the student answer data and the expected answer data provided with the template (which was generated by the teacher via workstation 108) and compares the expected answer for each answer region 304 to the student answer using the rules for evaluating that may be provided with the expected answer data. The evaluator module 148 generates an evaluation result for each answer region 304.

At step 616, the grader module 150 processes the evaluation results and assigns a grade to the worksheet 300 using the grading rules provided with the template. The teacher may view, correct, and verify the evaluation results and grade from workstation 108, e.g., via a GUI provided with the workstation 108.

In one embodiment of the worksheet evaluator system 100, the server 102 and data storage facility 104, referred to as the worksheet generation (WGS) provider 150, provide a service to a client 160. The client includes the MFD 106 and the workstations 108. Each client 160 may gain access to the service provided by the WGS provider 150, such as by subscribing to the service and/or loading appropriate software onto at least one MFD 106 and/or workstations 108. It is also envisioned that the WGS provider 150 provides a website that the client 160 can access and use to access the service provided by the WGS provider 150. The clients 160 may access the service for submitting a request for evaluation of a worksheet 300.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A worksheet evaluator system for evaluating worksheets administered to at least one student, the system comprising:
at least one tangible processor; and
a memory with instructions to be executed by the at least one tangible processor for:
accessing a digitally stored image of a worksheet that was administered to a student of the at least one student, wherein the worksheet includes the presentation of at least one problem for the student to respond to and each problem presentation includes an answer region that the student manually, mechanically, or electronically marked an answer to the problem in the answer region using a variety of alphanumeric characters;
generating expected answer data that provides an expected answer for each answer region;
locating each answer region in the image of the administered worksheet;
extracting from each located answer region the student's marks that are marked in the answer region;
processing the student's marks extracted from each answer region with character recognition processing (CRP) and storing the processed marks that correspond to each answer region as student answer data; and
evaluating the student answer data by comparing the student data with the expected answer data and generating corresponding evaluation data.

2. The worksheet evaluator system according to claim 1, further comprising the step of generating location data that describes the location of each answer region included in the image of the administered worksheet, wherein the locating includes using the location data to locate each answer region in the image of the administered worksheet.

3. The worksheet evaluator system according to claim 2, wherein the location data and expected answer data is user-entered via a computer having user interface for entering the location data.

4. The worksheet evaluator system according to claim 2, wherein the location data is generated by:
processing a digitally stored image of an answer sheet that is a copy of the worksheet which includes recognizable optical markings associated with each answer region;
locating each answer region by locating the optical markings associated with each answer region in the image of the of the answer sheet; and
storing location data that includes a location that corresponds to each located optical marking associated with each answer region.

5. The worksheet evaluator system according to claim 1, wherein the generating expected answer data includes:
processing a digitally stored image of an answer sheet that is a copy of the worksheet which includes recognizable optical markings and teacher manually, mechanically, or electronically entered marks associated with each answer region, wherein the teacher entered marks include a variety of alphanumeric characters;
locating each answer region by locating the optical markings associated with each answer region in the image of the answer sheet;
extracting from each located answer region the teacher's marks that are marked in the answer region; and
processing the teacher's marks extracted from each answer region with CRP and generating a corresponding expected answer for each answer region.

6. The worksheet evaluator system according to claim 5, wherein the evaluating includes applying rules for comparing the expected answer data and the student answer data and generating a corresponding evaluation result.

7. The worksheet evaluator system according to claim 6, wherein the evaluation rules are included with the teacher entered marks.

8. The worksheet evaluator system according to claim 1, wherein:
the worksheet further includes a name region and a worksheet ID region in which the student's name and the worksheet ID are manually, mechanically, or electronically entered using a variety of alphanumeric characters or encoded in an optical code; and
the memory further includes instructions to be executed by the at least one tangible processor for:
locating the name region and the worksheet ID region in the image of the administered worksheet;
extracting from the located name region and the worksheet ID region the student's name and the worksheet ID, respectively, that is marked in the name region; and
processing the extracted student's name and worksheet ID with CRP or an optical code decoding algorithm and storing at least one of the student answer data and the evaluation data in a database in association with at least one of the student's name or the worksheet ID.

9. The worksheet evaluator system according to claim 8, wherein the database stores in association with each student of the at least one student intelligent character recognition (ICR) training data including manual handwriting samples that have been processed with ICR, and the CRP includes processing the extracted student's marks with ICR, retrieving the student's ICR training data, and using it to improve accuracy of the ICR processing.

10. A method for evaluating worksheets to be administered to at least one student, the method comprising:
accessing by a tangible processor a digitally stored image of an answer sheet that is a copy of a worksheet, wherein the worksheet includes the presentation of at least one problem for a student of the at least one student to respond to and each problem presentation includes an answer region for the student to manually, mechanically, or electronically mark an answer to the problem in the answer region using a variety of alphanumeric characters, and the answer sheet includes recognizable optical markings associated with each answer region;
locating each answer region by the processer by locating the optical markings associated with each answer region in the image of the answer sheet;
storing by the processer location data that includes a location that corresponds to each located optical marking associated with each answer region;
generating by the processer expected answer data that provides an expected answer for each answer region;
accessing by the processer a digitally stored image of a worksheet that was administered to a student of the at least one student, wherein the student manually, mechanically, or electronically marked the answer region associated with each problem with an answer to the problem in the answer region using a variety of alphanumeric characters;
locating by the processer each answer region in the image of the administered worksheet using the location data;
extracting by the processer from each answer region located in the image of the administered worksheet the student's marks that are marked in the answer region;
processing by the processer the student's marks extracted from each answer region with character recognition processing (CRP) and storing the processed marks that correspond to each answer region as student answer data; and
evaluating by the processer the student answer data by comparing the student data with the expected answer data and generating corresponding evaluation data.

11. The method according to claim 10, wherein the image of the answer sheet further includes teacher entered marks associated with each optically marked answer region, and the generating expected answer data includes:
extracting from each answer region located in the image of the answer sheet the teacher's manually, mechanically, or electronically marks that are marked in the answer region, wherein the teacher entered marks include a variety of alphanumeric characters; and
processing the teacher's marks extracted from each answer region with CRP and generating a corresponding expected answer for each answer region.

12. The method according to claim 11, wherein the evaluating includes applying rules for comparing the expected answer data and the student answer data and generating a corresponding evaluation result.

13. The method according to claim 12, wherein the evaluation rules are included with the teacher entered marks.

14. The method according to claim 10, wherein:
the worksheet further includes a name region and a worksheet ID region in which the student's name and the worksheet ID are manually, mechanically, or electronically entered using a variety of alphanumeric characters or encoded in an optical code; and
the memory further includes instructions to be executed by the at least one tangible processor for:
locating by the processer the name region and the worksheet ID region in the image of the administered worksheet;
extracting by the processer from the located name region and the worksheet ID region the student's name and the worksheet ID, respectively, that is marked in the name region;
processing by the processer the extracted student's name and worksheet ID with CRP or an optical code decoding algorithm and storing at least one of the student answer data and the evaluation data in a database in association with at least one of the student's name or the worksheet ID.

15. The method according to claim 14, wherein the database stores in association with each student of the at least one student intelligent character recognition (ICR) training data including manual handwriting samples that have been processed with ICR, and the processing with ICR includes processing the extracted student's marks with ICR, retrieving the student's ICR training data and using it to improve accuracy of the ICR processing.

16. A method for evaluating worksheets to be administered to at least one student, the method comprising:
accessing by a tangible processor a digitally stored image of an answer sheet that is a copy of a worksheet, wherein the worksheet includes the presentation of at least one problem for a student of the at least one student to respond to and each problem presentation includes an answer region for the student to mark an answer to the problem in the answer region manually, mechanically, or electronically using a variety of alphanumeric characters, and the answer sheet includes recognizable optical markings associated with each answer region and manually, mechanically, or electronically teacher entered marks associated with each answer region that use a variety of alphanumeric characters;
locating each answer region by the processer by locating the optical markings associated with each answer region in the image of the answer sheet;
storing by the processer location data that includes a location that corresponds to each located optical marking associated with each answer region;
extracting from each answer region located in the image of the answer sheet the teacher's marks that are marked in the answer region;
processing the teacher's marks extracted from each answer region with character recognition processing (CRP) and generating a corresponding expected answer for each answer region;
accessing by the processer a digitally stored image of a worksheet that was administered to a student of the at least one student, wherein the student manually, mechanically, or electronically marked the answer region associated with each problem with an answer to the problem in the answer region using a variety of alphanumeric characters;
locating by the processer each answer region in the image of the administered worksheet using the location data;
extracting by the processer from each answer region located in the image of the administered worksheet the student's marks that are marked in the answer region;
processing by the processer the student's marks extracted from each answer region with CRP and storing the processed marks that correspond to each answer region as student answer data; and
evaluating by the processer the student answer data by comparing the student data with the expected answer data and generating corresponding evaluation data.

17. The method according to claim 11, wherein the evaluating includes applying rules for comparing the expected answer data and the student answer data and generating a corresponding evaluation result.

18. The method according to claim 12, wherein the evaluation rules are included with the teacher entered marks.

19. The method according to claim 10, wherein:
the worksheet further includes a name region and a worksheet ID region in which the student's name and the worksheet ID are manually, mechanically, or electronically entered using a variety of alphanumeric characters or encoded in an optical code; and
the memory further includes instructions to be executed by the at least one tangible processor for:
locating by the processer the name region and the worksheet ID region in the image of the administered worksheet;
extracting by the processer from the located name region and the worksheet ID region the student's name and the worksheet ID, respectively, that is marked in the name region;
processing by the processer the extracted student's name and worksheet ID with CRP or an optical code decoding algorithm and storing at least one of the student answer data and the evaluation data in a database in association with at least one of the student's name or the worksheet ID.

20. The method according to claim 14, wherein the database stores in association with each student of the at least one student ICR training data including handwriting samples that have been processed with intelligent character recognition (ICR), and the processing with CRP includes processing the extracted student's marks with ICR, retrieving the student's ICR training data and using it to improve accuracy of the ICR processing.
